(19) United States
(12) Patent Application Publication
(10) Pub. No.: US 2007/0032186 A1
(43) Pub. Date: Feb. 8, 2007

(54) Vehicle air purification system

(76) Inventors: Steven F. Clark, Buffalo, NY (US); David W. Miller, Clarence Center, NY (US)

Correspondence Address: PHILLIPS LYTLE LLP;INTELLECTUAL PROPERTY GROUP, 3400 HSBC CENTER, BUFFALO, NY, 14203-3509, US

(21) Appl. No.: 11/412,771

(22) Filed: Apr. 27, 2006

Related U.S. Application Data
(60) Provisional application No. 60/676,596, filed on Apr. 29, 2005.

(51) Int. Cl. B60H 3/06

(52) U.S. Cl. 454/158

(57) ABSTRACT

An air purifying device (15) for the cabin of a vehicle (32) comprising a housing (16) having mounting fixtures adapted to attach to the structure of a vehicle, a filter system (17) supported by the housing and having a first filter (18), a second filter (19), a third filter (20) and a fourth filter (21), and an air moving component (22) adapted and configured to move air from the cabin of the vehicle through the filter system. The first filter may be adapted to remove particulate matter that is greater than 10 microns, the second filter may comprise a gas phase air filter, the third filter may be adapted to remove particulate matter that is less than 2.5 microns, and the fourth filter may comprise a photo-catalytic oxidizer.

### CROSS-REFERENCE TO RELATED APPLICATIONS

This application claims the benefit of U.S. Provisional Patent Application No. 60/676,596, filed Apr. 29, 2005.

### TECHNICAL FIELD

The present invention relates generally to vehicles and air purifying devices, and in particular to an air purifying device especially adapted to be used integrally with a vehicle.

### BACKGROUND ART

Air purification systems are known in the prior art. Such devices have been adapted to filter the air in homes, surgical rooms and office spaces. However, conventional air purification systems are not adapted for use in a vehicle and are not designed to adequately clean the air in a vehicle cabin, which can become contaminated with vehicle exhaust.

Diesel exhaust from buses and other vehicles contains a number of chemicals that are known to be hazardous. In addition, studies have indicated that prolonged exposure to chemicals in diesel exhaust can significantly increase the risk of disease. Since many buses are diesel powered, such exhaust can migrate into and accumulate in the cabin of the bus, thereby exposing children riding the bus to high toxic levels. More than 98% of the particles omitted from diesel engines are very fine particles which can impair lung function and aggravate respiratory illness such as bronchitis and emphysema.

Hence, it would be beneficial to have an air purification device that may be easily mounted to a vehicle and positioned to filter the air in the interior cabin of a vehicle and which is especially adapted to eliminate, remove or reduce pollutants commonly found in vehicle emissions, such as carbon monoxide, carbon dioxide, hydrocarbons, nitrogen oxides and particulate matter.

### DISCLOSURE OF THE INVENTION

The present invention is directed to an air purifying device (15) which may be connected or mounted to the structural components of a vehicle (32) and which filters the air inside the cabin of the vehicle. The system generally comprises a housing (16) with mounting fixtures adapted to allow the device to be attached to the structure of the vehicle, a filter system (17) having a first stage filter (18), a second stage filter (19), a third stage filter (20), a fourth stage filter (21), and an air moving component (22) adapted to move air from the cabin of the vehicle through the filter system.

### BRIEF DESCRIPTION OF THE DRAWINGS

FIG. 1 is a partial transverse vertical sectional view of the improved air purification device mounted to the interior of a bus.

FIG. 2 is a partial longitudinal vertical sectional view of the rear of the bus and the air purification device shown in FIG. 1.

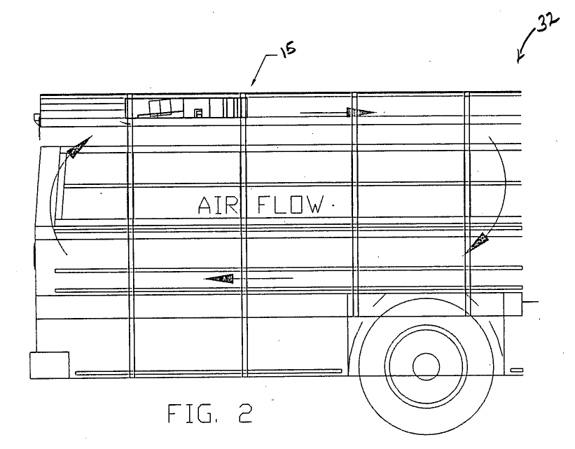

FIG. 3 is a perspective view of the air purification device shown in FIG. 1.

FIG. 4 is a longitudinal vertical sectional view of the air purification device shown in FIG. 3.

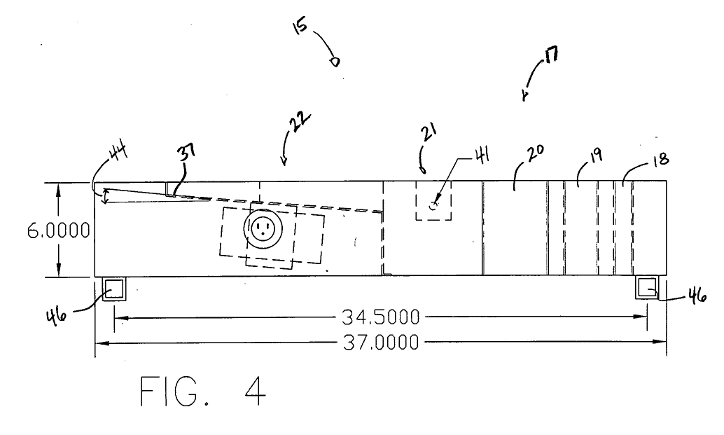

FIG. 5 is a top plane view of the air purification device shown in FIG. 3.

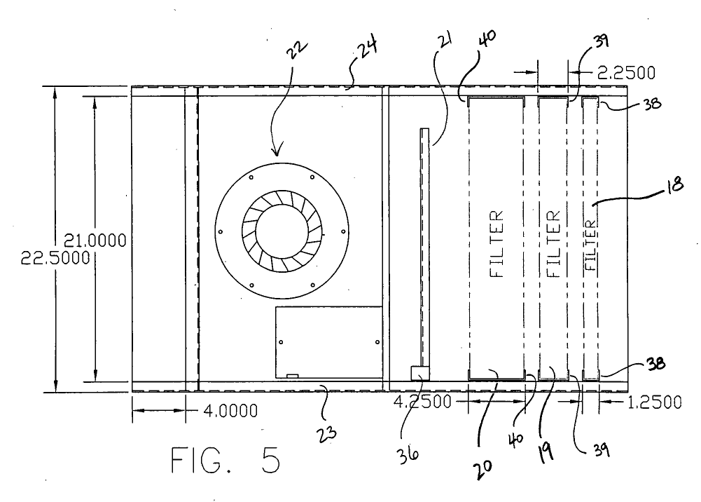

FIG. 6 is an exploded view of the air purification device shown in FIG. 3.

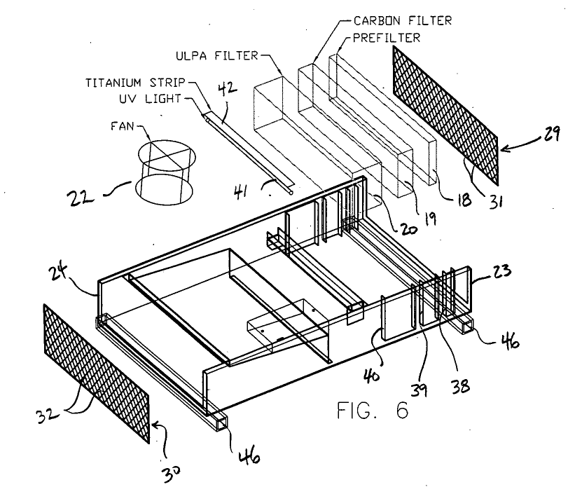

FIG. 7 is a detailed view of the attachment mechanism shown in FIG. 1.

FIG. 8 is a partial sectional view of the improved air purification device shown in FIG. 1 in a vertical orientation.

### DESCRIPTION OF THE PREFERRED EMBODIMENTS

At the outset, it should be clearly understood that like reference numerals are intended to identify the same structural elements, portions or surfaces consistently throughout the several drawing figures, as such elements, portions or surfaces may be further described or explained by the entire written specification, of which this detailed description is an integral part. Unless otherwise indicated, the drawings are intended to be read (e.g., cross-hatching, arrangement of parts, proportion, degree, etc.) together with the specification, and are to be considered a portion of the entire written description of this invention. As used in the following description, the terms “horizontal”, “vertical”, “left”, “right”, “up” and “down”, as well as adjectival and adverbial derivatives thereof (e.g., “horizontally”, “rightwardly”, “upwardly”, etc.), simply refer to the orientation of the illustrated structure as the particular drawing figure faces the reader. Similarly, the terms “inwardly” and “outwardly” generally refer to the orientation of a surface relative to its axis of elongation, or axis of rotation, as appropriate.

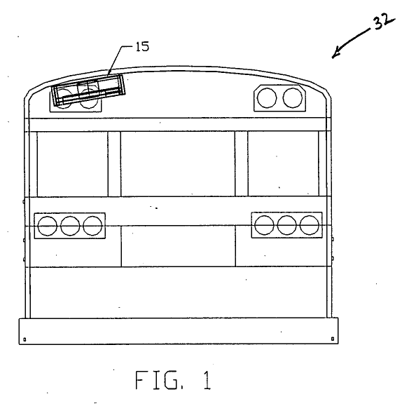

Referring now to the drawings and, more particularly, to FIG. 1 thereof, this invention provides an improved air purification device, of which the presently preferred embodiment is generally indicated at 15. Air purification device 15 removes from the air circulated through the device particulates and gases commonly found in diesel and gasoline engine emissions. The device is adapted to be mounted to the structure of the vehicle and positioned to clean the air in the cabin of the vehicle. Air purification device 15 generally comprises a housing 16, a filter system 17 having a series of filters 18-21 and an air mover device 22.

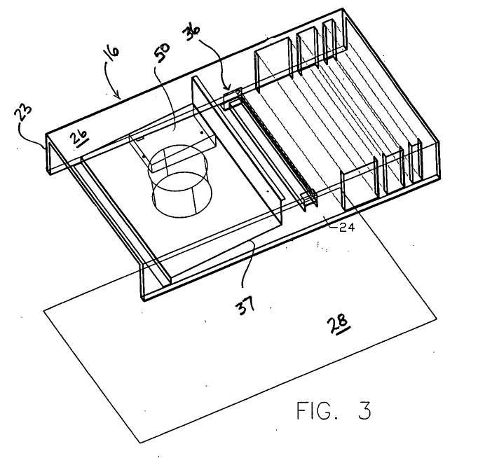

As shown in FIG. 3, housing 16 generally comprises a pair of longitudinally extending side walls 23 and 24, and a top plate 26 and opposed bottom plate 28 extending between the top and bottom edges respectively of side walls 23 and 24. Side wall 23, side wall 24, top plate 26 and bottom plate 28 are preferably constructed from metal, although other materials may be used. Two transverse end walls 29 and 30 extend between the respective ends of side walls 23 and 24. End walls 29 and 30 are provided with openings, severally indicated at 31 and 32, respectively, to permit air flow longitudinally through the housing. End wall 29 has a metal mesh grid having multiple air flow openings 31 and end wall 30 has a metal mesh grid having multiple air outlet openings 32. Side walls 23 and 24 are welded along their edges to the respective edges of end walls 29 and 30 and top plate 26 and bottom plate 28. In the preferred embodiment, the housing is constructed of twenty gauge welded steel and bottom plate 28 is a gasket panel which is attached to side walls 23 and 24 with multiple spaced screws that can be unscrewed to remove bottom plate 28 and provide access to the interior space of housing 16 and all the stages of filtration. As shown in FIG. 3, a series of pairs of tracks 38-40 are provided on the opposed inside surfaces of walls 23 and 24. The filter elements 18-20 extend transversely between walls 23 and 24 and are held in place at their ends by pairs of tracks 38, 39 and 40, respectively. A support shelf 36 is mounted to wall 23 and extends transversely from wall 23 to an endpoint which is supported by the inside of bottom plate 38. Shelf 36 supports filter system 21. A shelf 37 extends between walls 23 and 24 and air mover 22 is mounted to and supported by shelf 37. The housing is finished with a corrosion resistant baked-on powder coating.

As shown in FIG. 3, air purification device 15 includes an air mover 22 that facilitates air flow from the cabin through intake 31, through filter system 17 and back out to the cabin through outlet 32. In the preferred embodiment, mover 22 is a non-overloading motorized impeller which is made of plastic and has backward curved centrifugal fans. As shown in FIG. 3, mover 22 is supported by a shelf 38 that has been inclined at an angle 44 relative to horizontal bottom plate 38. This allows for the height of the unit to be reduced, which is beneficial because it allows device 15 to be mounted in the ceiling space of a vehicle such as a bus. An example of a suitable impeller is the R4E250 Series Motorized Impeller provided by EBM-PAPST Inc. of 100 Hyde Road, Farmington, Conn. 06034.

Filter system 17 is specially designed to filter gases and particulates found in vehicle emissions. Filter system 17 includes four filtering elements or stages 18-21 arranged in series and oriented transversely to side walls 23 and 24.

First stage filter 18 is a ten micron, self-sealing disposable pre-filter which protects the downstream gas phase and sub-micron stages of filtration system 17. Filter 18 is provided to remove particulate matter commonly found in vehicle emissions that is ten microns in size and larger. In the preferred embodiment, filter 18 has an internal frame and an integral gasket selvedge edge such that it fits in tracks 38. The media is a three-ply graduated laminate having all-synthetic pre-crimped Dacron polyester fibers bonded together in a self-sealing element. Each of the three laminates are graduated downward in diameter to form funnel shaped containment traps. An adhesive is applied between the last two laminates to retain filtered particulates. An example of a suitable first stage filter is the Tri-Dek 15/40 internal ring panel and link filter provided by Tri-Dim Filter Corporation, of 93 Industrial Drive, Louisa, Va. 23093.

Second stage filter 19 is a gas phase air filter. Filter 19 absorbs gas phase contaminants at a molecular level and is designed to absorb, chemisorb and/or oxidize carbon monoxide, nitrogen dioxide, nitric oxide, sulfur dioxide, hydrocarbons, and low molecular weight aldehydes, formaldehyde, hydrocarbons, organic acids, ozone and volatile organic compounds commonly found in vehicle emissions. Filter 19 includes a blend of three chemical filtration media. The first component includes activated carbon with non-fibrous aluminum oxide and potassium hydroxide. The second component is also a carbon based media and includes activated carbon with ash and phosphoric acid. The third component includes activated alumina impregnated with potassium permanganate. The media is provided as porous pellets that are housed in a disposable plastic module that requires no emptying or refilling. When the media inside the module is used up, the old module may be removed and replaced with a new one. The modules slide easily into and out of the purifying unit 15. Filter 19 fits in tracks 39. An example of a suitable module is the Triple-Blend Makeup Air Media provided by Purafil, of 2654 Weaver Way, Doraville, Ga. 30340.

Third stage filter 20 is an ultra low penetration air filter which provides fine filtration of sub-micron particulates. Filter 20 is provided to remove particulate matter commonly found in vehicle emissions that is 2.5 microns in size and smaller. In the preferred embodiment, third stage filter 20 has a micro-fiberglass media and provides an ULPA level 99.9995% minimum removal and retains 0.1 to 0.2 micron and larger size particles. Filter 20 fits in tracks 40. An example of a suitable third stage filter is the HiPerm Plus HA-8603 filter, provided by Hollingsworth & Vose, of 112 Washington Street, East Walpole, Mass. 02032.

Fourth stage filter 21 is a photo-catalytic oxidizer which uses germicidal photocatalytic oxidization to kill bacteria and viruses. It also provides the finishing stage for the oxidization of molecular contaminants such as carbon monoxide. In the preferred embodiment, oxidizer 20 is evaporator coil germicidal purifier having at least one photo-catalytic lamp 41 and 1 titanium strip 42. An example of a suitable photo catalytic oxidizer is the Second Wind Model 2218 evaporator coil germicidal purifier, provided by Elite Environmental Products, Inc. of 5216 Chesebro Rd., Agoura Hills, Calif. 91301.

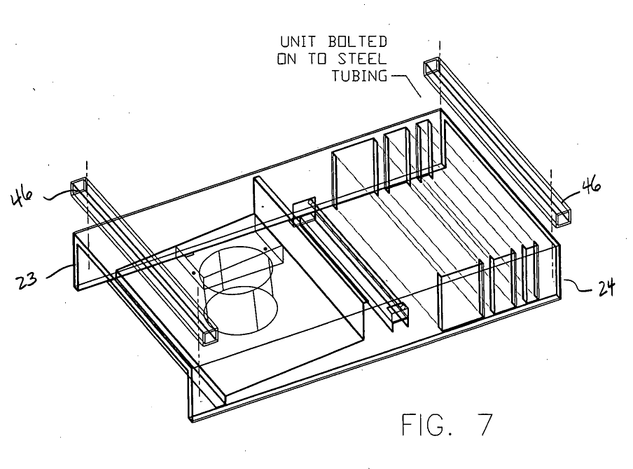

In the preferred embodiment, air purification unit 15 has an air flow capacity of 400 cubic feet per minute, an amp draw of 0.85 amps, a unit weight of 36 pounds, is 22 inches wide, 37.5 inches long and 6.5 inches high. As shown in FIG. 7, air purification unit 15 fits in the ceiling of vehicle 33 between the cross bearing members 34 of the roof of vehicle 31. Because fan 22 is inclined, the height of the unit is such that it does not extend a great distance below the inner surface of the cabin ceiling of bus 33. In this manner, the unit does not take up substantial space in the vehicle cabin. Unit 15 is positioned towards the rear of vehicle 32 and may be adapted to be powered using a converter and the wiring for the back emergency door light of vehicle 32. Alternatively, the unit may be powered directly from the battery of vehicle 32. Thus, unit 15 can be installed in previously manufactured vehicles. In this way, a fleet of vehicles can be retrofit with air purification units specially adapted to filter gases and particulates found in vehicle emissions.

As shown in FIG. 7, unit 15 is bolted to the cross-supports 46 in the roof of vehicle 32. While the preferred embodiment has been shown in FIG. 7 mounted in the ceiling of the vehicle, it is contemplated that other mounting positions may be used. For example, it is contemplated that the unit may be mounted to fit underneath the seat of a vehicle or may be mounted to fit behind the seat of a vehicle. For example, the unit might be mounted below the seat of a bus much like an under-the-seat heating unit. Alternatively, the unit may be mounted longitudinally above the seats much like air conditioning units in city buses.

As shown in FIG. 1, unit 15 is mounted to provide air flow in a clockwise direction longitudinally through the vehicle cabin. Air is drawn in through intakes 31, compelled through filtering system 17 and cleaned. The air is then exhausted through outlets 32 back into the cabin of the vehicle. In this way, emissions and contaminants typically found in vehicle exhaust, including diesel vehicle exhaust, migrating into the rear of the cabin from the tail pipe of the vehicle and/or migrating into the cabin through the floor of the vehicle are filtered from the air.

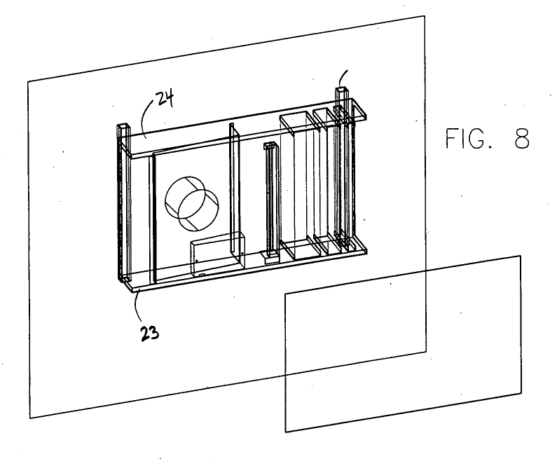

FIG. 8 shows an alternate mounting for unit 15. In this embodiment, unit 15 is not used in a vehicle, but instead is used in a room where vehicle exhaust typically accumulate, for example a garage, testing facility or other space that is in close proximity with vehicle exhaust. In this embodiment, the unit is mounted vertically against, or embedded into, a wall and wired directly into the AC power of the building. This embodiment uses the same filtration processes and the stages described above, so as to remove various vehicle emissions from buildings and/or rooms associated with vehicle exhaust. If embedded, the unit can be mounted between two vertically extending studs in the wall of the room.

The present invention contemplates that many changes and modifications may be made. Therefore, while the presently preferred form of the air purification system has been shown and described, and several modifications discussed, persons skilled in this art will readily appreciate that various additional changes and modifications may be made without departing from the spirit of the invention.

What is claimed is:

1. An air purifying device for the cabin of a vehicle comprising:
a housing having mounting fixtures adapted to attach to the structure of a vehicle;
a filter system supported by said housing and having a first filter, a second filter, a third filter, and a fourth filter; and
an air moving component adapted and configured to move air from said cabin of said vehicle through said filter system.

2. The device set forth in claim 1, wherein said housing comprises a first end wall having a first opening and a second end wall having a second opening, said openings configured to permit airflow longitudinally through said housing from said first opening to said second opening.

3. The device set forth in claim 1, wherein said air moving component is adapted to move air from said cabin into said housing through an inlet, through said filter system, and out of said housing through an outlet.

4. The device set forth in claim 1, wherein said housing has a top planar surface and a bottom planar surface and wherein said air mover is inclined at an angle relative to said surfaces.

5. The device set forth in claim 1, wherein said first filter is adapted to remove particulate matter that is 10 microns in size and larger.

6. The device set forth in claim 5, wherein said first filter comprises a three-ply graduated laminate.

7. The device set forth in claim 1, wherein said second filter comprises a gas phase air filter adapted to absorb gas phase contaminants.

8. The device set forth in claim 7, wherein said second filter is configured to absorb, chemisorb and/or oxidize gases selected from a group consisting of carbon monoxide, nitrogen dioxide, nitric oxide, sulfur dioxide, hydrocarbons, low molecular weight aldehydes, formaldehyde, and ozone.

9. The device set forth in claim 7, wherein said filter comprises a blend of three chemical filtration media.

10. The device set forth in claim 9, wherein said filtration media comprises activated carbon.

11. The device set forth in claim 9, wherein said filtration media comprises activated alumina impregnated with permanganate.

12. The device set forth in claim 1, wherein said third filter is adapted to remove sub-micron particulates.

13. The device set forth in claim 12, wherein said third filter is adapted to remove particulate matter that is less than 2.5 microns in size.

14. The device set forth in claim 12, wherein said third filter provides an ULPA level 99.9995% minimum removal and retains particulates greater than about 0.1 microns.

15. The device set forth in claim 1, wherein said fourth filter comprises a photo-catalytic oxidizer.

16. The device set forth in claim 15, wherein said fourth filter comprises at least one photo-catalytic lamp.

17. The device set forth in claim 15, wherein said fourth filter comprises a titanium strip.

18. The device set forth in claim 1, wherein said housing, filter system and air moving component are configured and arranged to provide an airflow capacity of at least 400 cubic feet per minute.
